(19) United States
(12) Patent Application Publication
(10) Pub. No.: US 2004/0103223 A1
(43) Pub. Date: May 27, 2004

(54) USB accessory adaptor

(75) Inventors: William A. Gabehart, Fort Worth, TX (US); Reginald E. Richardson, Arlington, TX (US)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 10/304,883

(22) Filed: Nov. 26, 2002

(51) Int. Cl. G06F 3/00

(52) U.S. Cl. 710/2

(57) ABSTRACT

A Universal Serial Bus (USB) adaptor (16, 16′, 16″), compatible with standard USB connectors, provides a simplified interface between a portable communications device (12) and a USB accessory (14, 14″). An encoder (28) provides an operating state to the portable communications device (12), enabling the portable communications device (12) to perform as either a USB host or a USB function accessory. A function adaptor (16′) selects its DC power source and is capable of providing DC power to a function accessory (14′). The host adaptor (16) can obtain DC power from a host accessory (14), according to USB standards.

### BACKGROUND OF THE INVENTION

1. Field of the Invention

The present invention relates to communications, and specifically to interfacing communications devices with peripheral devices using USB technology.

2. Description of Related Art

Communications devices are currently being designed to support a number of new features and accessories. For instance, portable smartphones are being designed to internally support game controllers, cameras, scanners and other peripheral devices.

Presently, connecting such peripheral devices to a portable communications device may require a number of special cables and adaptors, increasing the complexity and cost of the system. However, many peripheral devices are currently being manufactured with Universal Serial Bus (USB) technology to simplify the interfacing of a function accessory, or peripheral device, to a host (typically a personal computer or microprocessor). USB technology allows a user to simply plug in a USB function connector (commonly referred to as an “A” connector) to a host connector (“B” connector) and provides for immediate recognition and utilization of the function accessory by the host (assuming that the host has the requisite software to support the function accessory). Therefore, a personal computer or microprocessor associated with a USB connector or port has the capability to connect to and disconnect from devices while it is turned on, as well as to detect those devices without the need for a system reboot.

However, applying USB technology to portable communications devices presents numerous challenges. In order for USB accessories to be compatible with portable communications devices, which are usually not designed with USB ports, an adaptor is needed which meets specific criteria. First, the adaptor must provide a portable communications device operating state to the portable communications device, as a portable communications device can act as either a function accessory or a host. If the portable communications device is not provided with its appropriate operating state, it is unlikely that the accessory will properly communicate with the portable communications device, since the portable communications device may not recognize the accessory or receive the appropriate data. Second, if the portable communications device is acting as a host, the adaptor must be capable of providing power to the function accessory, according to standard USB protocols for low power accessories (i.e., a mouse). Third, the adaptor must be compatible with a USB “A” or “B” connector and must be able to send and transmit data over USB data lines to enable the adaptor to connect with any USB accessory, regardless of whether the portable communications device is acting as a host or function accessory.

Currently, there is no adaptor that satisfies all of these criteria and thus a need exists for a USB accessory adaptor that is capable of providing the above-discussed functional features.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of an exemplary mobile communications network in which a portable communications device communicates with a USB host accessory via a USB host adaptor;

FIG. 2 is a block diagram of the USB host adaptor of FIG. 1;

FIG. 3 is a block diagram of an exemplary mobile communications network in which a portable communications device communicates with a USB function accessory via a USB function adaptor;

FIG. 4 is a block diagram of the USB function adaptor of FIG. 3;

FIG. 5 is a block diagram of an exemplary mobile communications network in which a portable communications device communicates with a USB function accessory, either host or function, via a USB adaptor that is either a host or function adaptor; and

FIG. 6 is a block diagram of the USB adaptor of FIG. 5.

### DETAILED DESCRIPTION OF THE PRESENTLY PREFERRED EXEMPLARY EMBODIMENTS

In overview, the present disclosure concerns systems, procedures, and equipment or apparatus that interface a communications device with an accessory. More particularly various inventive concepts and principles embodied in adaptor devices and methods therein for providing a universal serial bus (USB) adaptor for interfacing a communications device, such as a portable communications device with a USB accessory, where either the accessory or device is a host or function, for the convenience and advantage of users of such devices and accessories or consumers of services facilitated by these devices and accessories are discussed and described. This USB adaptor may be especially beneficial for cellular handsets, personal digital assistants, and the like.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented or supported with or by software programs or instructions and possibly integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the preferred embodiments.

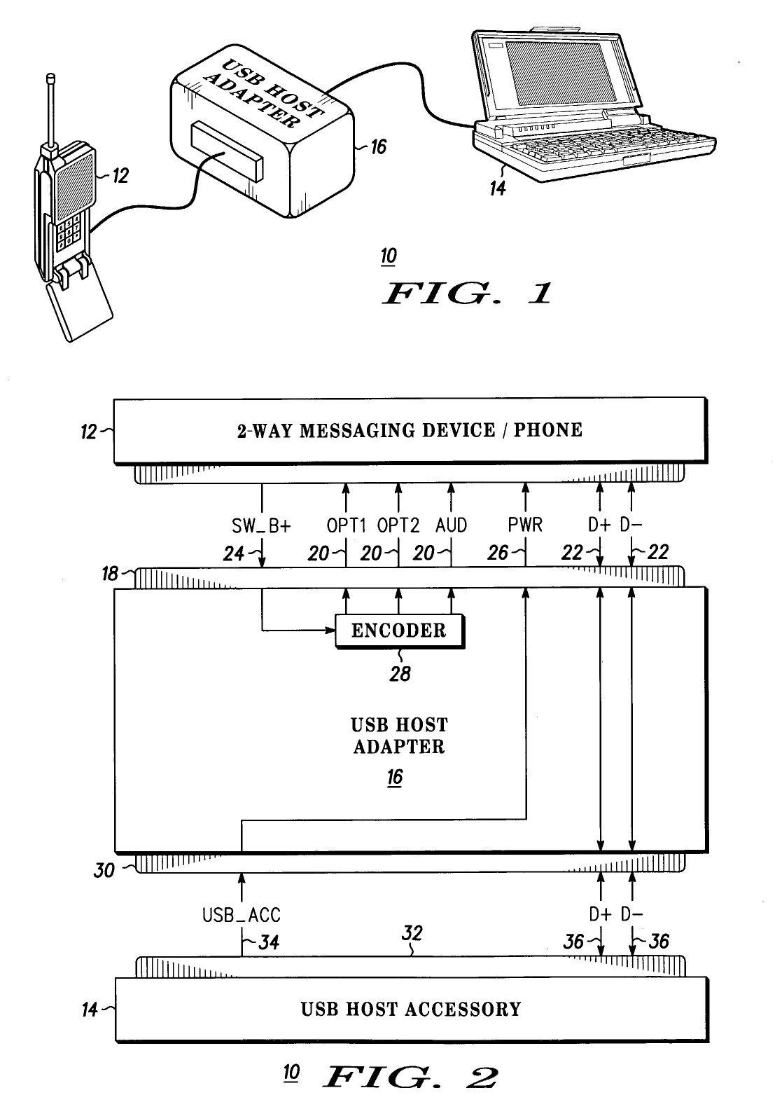

Referring now to the drawings in which like numerals reference like parts, FIG. 1 shows a mobile communications network 10 that includes a portable communications device 12, a USB host accessory (host accessory) 14, and a USB host adaptor (host adaptor) 16. The portable communications device 12 may be any type of portable phone, data or messaging device such as, for example, a code division multiple access (CDMA) or GSM type cellular telephone or a smartphone that is capable of communicating with other like portable devices or with public switched telephone network landline devices using conventional cellular systems and protocols. The portable communications device may also be any type of device, such as a personal digital assistant (PDA), which typically does not include independent communications capabilities but can communicate when connected to a device with such communications capabilities. The host accessory 14 may be any type of electronic device having a USB “B” connector such as, for example, a personal computer or a microprocessor, and the ability to communicate data to a USB “A” connector.

As shown in FIG. 2, the host adaptor 16 has a first connector 18 for connecting to the portable communications device 12. The first connector 18 includes a plurality of logic lines 20 with corresponding connecting elements (Opt1, Opt2, and Audio_In in this embodiment) and, for example, an appropriate connector). The first connector 18 also includes data connecting elements 22 (D+ and D−) for enabling the communication of data between the portable communications device 12 and the host adaptor, thus the host accessory 14, and two direct current (DC) power connectors or connecting elements: a SW_B+ connector 24 for connecting the DC power, preferably switched DC power or power signal level or voltage level, from the portable communications device to the host adaptor 16 and a USB_PWR connector or connecting element 26 for supplying DC power, when required, to the portable communications device 12 from the host accessory 14 via the USB host adaptor 16.

The host adaptor 16 also includes an encoder 28 for providing an operating state or logic state to the portable communications device 12 over the logic lines 20. Preferably the encoder 28 detects the DC power from the portable communications device 12 via the SW_B+ connector 24 and adjusts and provides logic states or levels appropriate for the particular portable communications device 12 that the host adaptor 16 is connected to through the connector 18. The operating state, USB Host or USB Function, of the portable communications device 12 is determined based upon the particular logic levels or states that the encoder 28 provides via the logic lines 20 in addition to whether USB_ACC power is detected as discussed below. The encoder 28 may include pull up/pull down resistors (not shown) that are hard wired or coded to supply preset binary codes or a logic state, corresponding to a USB host or USB function operating mode, to the portable communications device 12 over the logic lines 20.

The USB host adaptor 16 also includes a second connector 30 that is preferably a standard USB “A” connector for connecting the host adaptor 16 to a standard USB “B,” or host, connector 32 of the host accessory 14. The second connector 30 includes a further DC power connector, USB_ACC connector 34, for receiving DC power from the host accessory 14, as well as data connecting elements 36 (D+ and D−) for enabling data communications between the host accessory 14 and the portable communications device 12 via the host adaptor 16 and corresponding data connecting elements 22. The host adaptor 16 may obtain its DC power from and provide power to the portable communications device 12 using the output power of the host accessory 14 via the USB_ACC connector 34 or connecting element of connector 30. In order for the present host adaptor 16 to provide DC power to the portable communications device 12, it may be necessary to include a power converter (not shown) to adjust, manage, and control the voltage supplied by the host accessory 14 to meet the requirements of the portable communications device 12 and those of the host adaptor 16. In addition, the presence or absence of power at USB_ACC connector 34 upon connection with the connector 30 is also used to help determine the operating state of the portable communications device 12, since the USB standard requires that host accessories supply power.

The operation of the host adaptor 16 will now be described by way of the following example. If an adaptor is needed to connect the host accessory 14 to the portable communications device 12 when the host accessory 14 is a personal computer or similar host device and the portable communications device 12 is a smartphone such as a T720 manufactured by Motorola, the connector 18 of the host adaptor 16 is coupled to a connector (not shown) on the smartphone. The output voltage of the smartphone will be transmitted through the SW_B+ connector 24 and received at the encoder 28. The encoder 28 will use pull up/pull down resistors to adjust the voltage levels of the logic lines 20 to logic levels that the smartphone will recognize as the operating state to support a USB host accessory, provided power is detected at USB_ACC connector 34.

In practice the second connector, specifically the USB_ACC connector, and the encoder, specifically logic lines emanating there from, are operably coupled to a processor. The processor (not specifically shown) is preferably within the portable communications device 12 but may optionally be located elsewhere such as within the adaptor. The processor operates to decode the logic states of the logic lines and whether DC power or a voltage level corresponding thereto is available at the connector 34 to determine the proper operating state, USB Host or USB function, of the portable communications device. For example, when the encoder is programmed to communicate a function operating state to the portable communications device, the processor may determine a USB function operating state for the portable communications device responsive to detecting DC power present at the DC power connecting element 34 (34′ in FIG. 4) of the connector 32 (32′ in FIG. 4). Alternatively, the processor may determine a USB host operating state for the portable communications device 12 responsive to detecting absence of DC power at the DC power connecting element 34, 34′ of the connector 32, 32′.

The data connecting elements 22 (D+ and D−) will then be enabled for data transmission and reception, and the smartphone will therefore be designated as a USB function accessory. If the personal computer is then coupled to the host adaptor 16 via the connector 32, power can be transmitted through the USB_ACC connector 34 to the host adaptor 16, corrected to an appropriate voltage through a power converter (not shown) if need be, and ultimately sent to the smartphone through the USB_PWR connector 26. The data connecting elements 36 (D+ and D−) can then be used to transmit data to and from the personal computer through the host adaptor 16 to the smartphone.

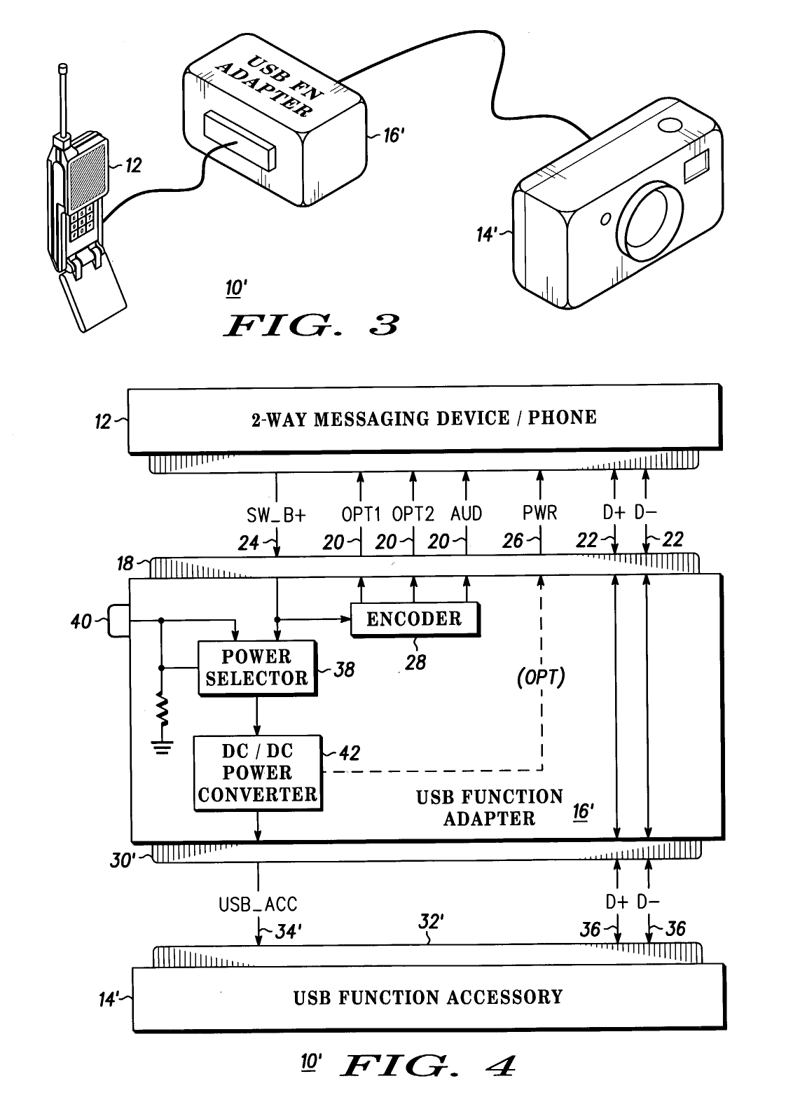

The structure and operation of the function adaptor 16′ will now be discussed, with components identical to those components in the host adaptor of FIGS. 1 and 2 being identified with like reference numerals. FIG. 3 shows a mobile communications network 10′ that includes a portable communications device 12, a USB function accessory 14′, and a USB function adaptor (function adaptor) 16′. The function accessory 14′ may be any type of electronic device having a USB “A” connector such as a digital camera, a printer, a keyboard, a mouse, a joystick, or the like, with the ability to communicate data via a USB “B” connector.

Referring to FIG. 4, the USB function adaptor 16′ includes a second connector 30′ that is preferably a standard USB “B” connector. The second connector 30′ connects to the function connector 32′, preferably via a standard USB “A” connector, of the function accessory 14′. A power selector 38 enables the function adaptor 16′ to select its DC power source. Specifically, if present and detected, an external power source is preferable; however, if no external power source is detected at an external power source connector 40, the portable communications device 12 may function as the DC power source of the adaptor 16′ and utilize the portable communications device 12 DC power from the SW_B+ connector 24. The power selector 38 may be a multiplexer (MUX), a switch, or any device that is able to select one power option over another, and the DC power from the power selector 38 can be used, when needed, as input power for the function accessory 14′, transmitted via the USB_ACC connector 34′, after having been adjusted to a preferable voltage level according to USB standards in a DC/DC power converter 42, such as a DC/DC buck/boost power converter. In the embodiment shown in FIG. 4, the pin to the USB_PWR connector 26 is coupled in a representative manner to the DC/DC power converter 42, as the function accessory 14′ does not provide power to the portable communications device 12. However if an external power source is available the portable communications device may be supplied power, after proper conditioning, from the converter 42 via pin 26 or any other pin on the connector to the portable communications device.

The operation of the function adaptor 16′ will now be described by way of the following example. If an adaptor is needed to connect the function accessory 14′ to the portable communications device 12 when the function accessory 14′ is, for example, a digital camera and the portable communications device 12 is a smartphone such as a T720 phone manufactured by Motorola, the connector 18 of the function adaptor 16′ is coupled to a connector (not shown) on the smartphone, the output voltage of the smartphone will be transmitted through the SW_B+ connector 24, and the encoder 28 will use pull up/pull down resistors to adjust the voltage levels of the logic lines 20 to logic levels that the smartphone will recognize as the operating state for a USB host, provided that power is not detected at connector 30′ from USB_ACC connector 34′. The power selector 38 will detect via known techniques if an external DC power source is connected to the external power source connector 40. If so, the power selector 38 selects the external power source as the power source for the function adaptor 16′ and for the digital camera, and transmits or sends appropriately conditioned DC power via the USB_ACC connector 34′ to the digital camera. If an external power source is not connected to the external power source connector 40, the power selector 38 will select the output voltage or DC power from the smartphone, transmitted through the SW_B+ connector 24, as the power source for the function adaptor 16′ and thus function accessory 14′. The data connecting elements 22 (D+ and D−) are then enabled for data transmission and reception, and the pin to the USB_PWR connector 26 is, preferably but not necessarily, grounded. The smartphone will be designated as a USB host for the digital camera via, preferably, the processor of the portable communications device as discussed above.

If the digital camera is then coupled to the function adaptor 16′ via the connector 32′, the voltage from the selected power source is then adjusted in the DC/DC power converter 42 to an appropriate voltage according to USB standards and sent or provided to the digital camera through the USB_ACC connector 34′. Communication between the smartphone (host) and the digital camera (function) can occur over the data connecting elements 22 and 36 (D+, D−, D+′, and D−′).

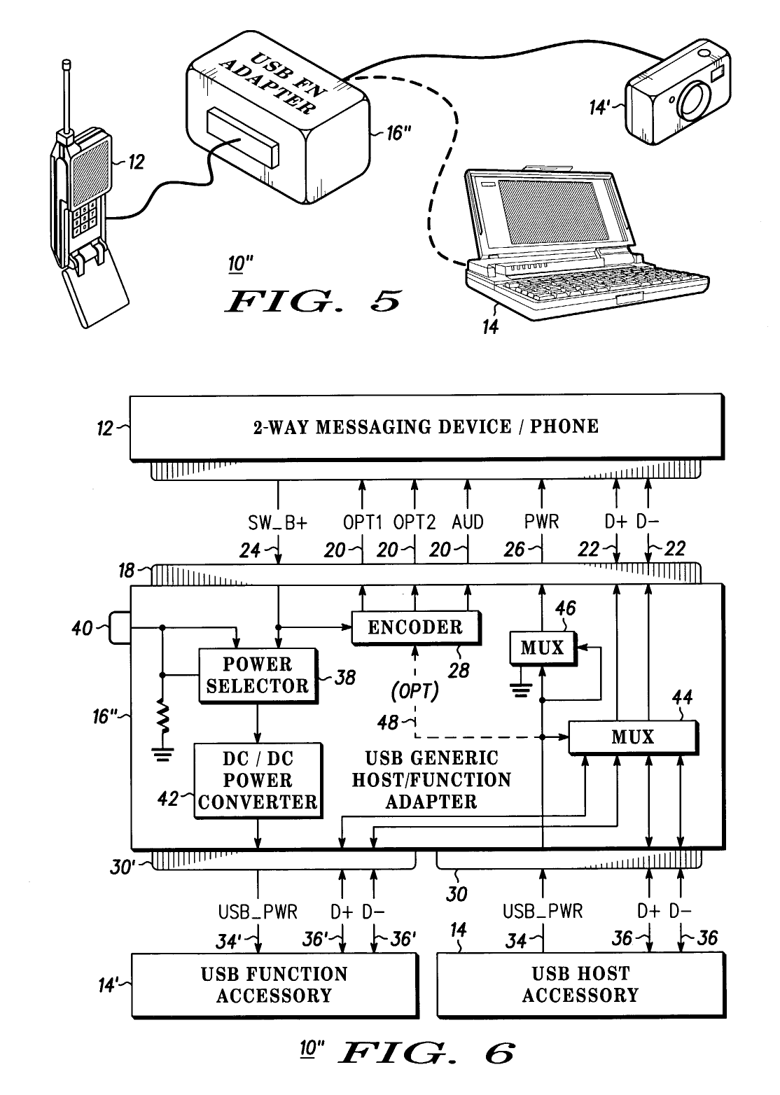

Referring to FIG. 5, a block diagram of an exemplary mobile communications network in which a portable communications device 12 communicates with a USB accessory, either USB host accessory 14 or USB function accessory 14′, via a USB adaptor 16″ that operates as either a host adaptor or function adaptor will be discussed and described. Generally the adaptor 16″ is expected to act at any one time as a host adaptor or a function adaptor. Referring to FIG. 6, this will be determined by whether a USB function accessory or a USB host accessory is coupled to the USB adaptor at the connector 30′ or connector 30. In the preferred form if both are connected, the USB adaptor 16″ will act as a USB host adaptor and only recognize the USB host accessory. Therefore the USB function accessory will not be recognized or functional if both are physically connected.

Continuing with FIG. 6, the adaptor 16″ includes the connector 18 that further includes the logic lines 20, the data connecting elements 22, the SW_B+ connector 24 and DC power connector 26 that generally operate as above described to interface the adaptor 16″ to the portable communications device 12 when the device is operating as either a USB host or USB function, respectively. The USB adaptor 16″ also includes the power selector 38 and DC/DC converter 42 that operate analogously as above discussed to supply DC power to a USB function accessory from either an external source at the external power connector 40 or the portable communications device 12. Further included is the encoder 28 that operates to supply the proper logic states on the logic lines 20 in order to communicate to the portable communications device the appropriate operating state when DC power is applied at the DC power connecting element 24. Note that in this instance the encoder may supply the same logic states for either a Host or Function accessory however alternatively the logic states may change depending on the type of USB accessory.

New elements included in the USB adaptor 16″ include the multiplexer 44 and 46. The multiplexer 44 selectively enables the portable communications device 12 to communicate or exchange data with a USB function accessory 14′ via data connecting elements 22 and 36′ or a USB host accessory 14 via data connecting elements 22 and 36. The multiplexer 46 controls whether DC power from the USB accessory is provided at power connecting element 26 to the portable communications device and this happens only when a USB host accessory 14 is connected to connector 30. The multiplexer 44 is normally set in or to a USB function adaptor mode to couple the data connecting elements 36′ via connector 30′ to the data connecting elements 22 and the multiplexer 46 normally couples or applies a ground to the DC power connecting element 26.

However when a USB host accessory is coupled to the connector 30, the DC power from the USB host accessory at the DC power connecting element 34 of connector 30 is coupled to control inputs for the multiplexers 44, 46 as well as the input of multiplexer 46. This DC power or specifically corresponding voltage level results in the multiplexer 44 switching to a USB host adaptor mode, thus isolating or decoupling the data connecting elements 36′ via the connector 30′ and coupling the data connecting elements 36 via connector 30 to the data connecting elements 22, thereby enabling data to be communicated between the USB host accessory, USB adaptor, and portable communications device. The multiplexer 46 is also controlled by the DC power from the USB host to couple the DC power to the power connecting element 26. Optionally the DC power or corresponding voltage level may be coupled via 48 to the encoder 28 if one or more changes in logic states for logic lines 20 in addition to the DC power at connecting element 26 are required in order to distinguish a USB function versus USB host operating state or mode for the portable communications device.

Therefore, in view of the foregoing, a USB adaptor is provided as either a host or a function adaptor to enable communication between a portable communications device and a USB host or function accessory. Therefore, adaptor circuitry and components need not be included in the portable communications device, thereby enabling the portable communications device to be manufactured without additional cost, weight or complexity while providing USB function and host communication capability and flexibility with minimum overall additional system cost or complexity. Also note that one physical adaptor may be constructed that may be configured as either a USB host or function adaptor as required thereby reducing a large number of interface cables and adaptors to one adaptor that can handle the interface requirements for many USB accessories.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A Universal Serial Bus (USB) adaptor for interfacing a portable communications device with a USB accessory, comprising:
a first connector for connecting to the portable communications device, the first connector including a plurality of logic line connecting elements for connecting to logic lines in the portable communications device and at least one first USB data connecting elements for enabling data to be communicated between the portable communications device and the USB adaptor;
an encoder for communicating an operating state to the portable communications device over at least one of the plurality of logic line connecting elements of the first connector; and
a second connector for connecting to the USB accessory, the second connector including a first power connecting element for one of receiving direct current (DC) power from and sending DC power to the USB accessory, and at least one second USB data connecting elements for enabling data to be communicated between the USB accessory, the USB adaptor, and the portable communications device.

2. The USB adaptor of claim 1, wherein the first connector further includes a second power connecting element for receiving DC power from the portable communications device, and wherein the encoder is coupled to the second power connecting element.

3. The USB adaptor of claim 1, wherein the encoder is hardwired to communicate a USB function accessory operating state to the portable communications device.

4. The USB adaptor of claim 1, wherein the encoder is hardwired to communicate a USB host operating state to the portable communications device.

5. The USB adaptor of claim 4 further comprising an external power connector for providing DC power from an external power source to the USB adaptor.

6. The USB adaptor of claim 5, wherein the first connector further includes a second power connecting element for receiving DC power from the portable communications device, the USB adaptor further comprising a power selector for selecting one of the external power source and the DC power from the portable communications device to provide DC power for the USB accessory.

7. The USB adaptor of claim 6, wherein the power selector is one of a multiplexer and a switch.

8. The USB adaptor of claim 6, further comprising a DC/DC power converter for adjusting a voltage level corresponding to the DC power supplied to the USB accessory.

9. The USB adaptor of claim 1, wherein the encoder is arranged to adjust a logic state to one of a USB host and a USB function operating state for the portable communications device.

10. The USB adaptor of claim 1 wherein the first connector further includes a third power connecting element for supplying DC power from the USB accessory to the portable communications device.

11. The USB adaptor of claim 1 wherein the second connector and the encoder are operably coupled to a processor, for determining the operating state of the portable communications device.

12. The USB adaptor of claim 11 wherein the processor determines a USB function operating state for the portable communications device responsive to detecting DC power present at the third power connecting element of the second connector.

13. The USB adaptor of claim 11 wherein the processor determines a USB host operating state for the portable communications device responsive to detecting absence of direct current power at the third power connecting element of the second connector.

14. The USB adaptor of claim 1 further including a multiplexer for selectively coupling one of at least one USB data connecting element corresponding to a USB function accessory and at least one USB data connecting element corresponding to a USB host accessory to the at least one first USB data connecting elements.

15. The USB adaptor of claim 14 wherein the second connector is for connecting to one of a USB function accessory and a USB host accessory and when a USB function accessory is connected the multiplexer couples the at least one USB data connecting element corresponding to the USB function accessory and when a USB host accessory is connected the multiplexer couples the at least one USB data connecting element corresponding to the USB host accessory to the at least one first USB data connecting elements.

16. The USB adaptor of claim 15 wherein the multiplexer is controlled according to the presence of DC power from the USB host accessory

17. A Universal Serial Bus (USB) function adaptor for interfacing a portable communications device with a USB function accessory, comprising:
a first connector for connecting to the portable communications device, the first connector including a plurality of logic line connecting elements for connecting to logic lines in the portable communications device, a first power connecting element for receiving direct current (DC) power from the portable communications device, and at least one first USB data connecting elements for enabling data to be communicated between the portable communications device and the USB function adaptor;
an encoder for communicating a host operating state to the portable communications device over at least one or more of the plurality of logic line connecting elements of the first connector; and
a second connector for connecting to the USB function accessory, the second connector including a second power connecting element for sending at least a portion of the DC power, when required, to the USB function accessory, and at least one second USB data connecting elements for enabling data to be communicated between the USB function accessory, the USB function adaptor, and the portable communications device.

18. The USB function adaptor of claim 17, further comprising an external power connector for providing DC power from an external power source to the USB function adaptor.

19. The USB function adaptor of claim 17, further comprising a DC/DC power converter for adjusting a voltage level corresponding to a DC power required by the USB function accessory.

20. The USB function adaptor of claim 18, further comprising a power selector for selecting one of the DC power provided by the external power source and the DC power received from the portable communications device to provide the DC power for the USB function accessory.

21. The USB function adaptor of claim 20, wherein the power selector is one of a multiplexer and a switch.

22. The USB function adaptor of claim 17 wherein the first connector further includes a third power connecting element for supplying DC power from the USB function adaptor to the portable communications device

23. A Universal Serial Bus (USB) host adaptor for interfacing a portable communications device with a USB host accessory, comprising:
a first connector for connecting to the portable communications device, the first connector including a plurality of logic line connecting elements for connecting to logic lines in the portable communications device, a first power connecting element for sending a direct current (DC) power from the USB host adaptor to the portable communications device, and at least one first USB data connecting elements for enabling data to be communicated between the portable communications device and the USB host adaptor;
an encoder for communicating a function operating state to the portable communications device over at least one of the plurality of logic line connecting elements of the first connector;
a second connector for connecting to the USB host accessory, the second connector including a second power connecting element for receiving DC power from the USB host accessory to be provided to the portable communications device, and at least one second USB data connecting elements for enabling data to be communicated between the USB host accessory, the USB host adaptor, and the portable communications device.
